(19) United States
(12) Patent Application Publication
(10) Pub. No.: US 2007/0294819 A1
(43) Pub. Date: Dec. 27, 2007

(54) Sauna with infrared emitter

(75) Inventor: Andre L. Levesque, Grand Rapids, MI (US)

Correspondence Address: MCGARRY BAIR PC, 32 Market Ave. SW, SUITE 500, GRAND RAPIDS, MI, 49503, US

(73) Assignee: GRAND PACKAGING, LLC, Wayland, MI (US)

(21) Appl. No.: 11/767,794

(22) Filed: Jun. 25, 2007

Related U.S. Application Data
(63) Continuation-in-part of application No. 11/465,903, filed on Aug. 21, 2006.
(60) Provisional application No. 60/746,214, filed on May 2, 2006.

(51) Int. Cl. A61H 33/06

(52) U.S. Cl. 4/524; 392/416

(57) ABSTRACT

A sauna comprises a radiant heating element for supplying heat to the interior of a sauna cabinet. A cover is disposed between the radiant heating element and the interior, and has multiple openings sized to prevent the insertion of a finger.

### CROSS-REFERENCE TO RELATED APPLICATIONS

This application is a continuation-in-part of U.S. patent application Ser. No. 11/465,903, filed Aug. 21, 2006, and claims priority on U.S. Patent Application No. 60/746,214, filed May 2, 2006, with the disclosure of both applications being incorporated by reference.

### BACKGROUND OF THE INVENTION

1. Field of the Invention

The present invention relates generally to sauna with a radiant heater, and more particularly to an infrared emitter unit for a sauna.

2. Description of the Related Art

Saunas are popular devices used by many individuals for relaxation and other health benefits, such as stress relief, pain relief, improved blood circulation, strengthened cardiovascular system, and improved skin appearance. Conventional saunas comprise a closed room having a heat source for supplying heat to the room and to the sauna user. Generally, a sauna is one of two types—a “wet” sauna that utilizes heated steam as the heat source and a “dry” sauna that utilizes a heat source with little or no steam.

Infrared saunas, sometimes referred to as far infrared (FIR) saunas have gained popularity as an alternative to traditional dry saunas. Infrared saunas employ an infrared radiant heating mechanism instead of rocks warmed by an electric heater as used in traditional dry saunas, such as the Finnish sauna. Infrared heating mechanisms typically comprise an infrared emitter that can become extremely hot as the sauna is heated to an operating temperature, which can range from 100° F. to 190° F. The infrared heaters are normally accessible by the user and the user should be protected from accidental contact with the heating elements of the infrared heater.

### SUMMARY OF THE INVENTION

According to one aspect of the present invention, a sauna comprises a cabinet defining an interior and having an opening providing access to the interior, a door mounted to the cabinet and moveable between a closed position, where the door blocks human access from an exterior of the cabinet through the opening to the interior, and an open position, where human access is permitted from the exterior through the opening to the interior, a radiant heating element supplying heat to the interior, and a cover disposed between the radiant heating element and the interior and having multiple openings, each opening having an effective size to prevent the insertion of a child's finger having a standard size.

In one embodiment, the effective size is less than 0.3 inches. The effective size can be ¼ inch.

In another embodiment, the radiant heating element comprises an infrared emitter.

In yet another embodiment, the openings are hexagonal. The hexagonal openings can have a maximal diameter of ¼ inch.

In still another embodiment, the sauna can further comprise a housing mounted to the cabinet and in which the radiant heating element is located, with the housing having a rear wall from which extends a multifaceted peripheral side wall, with each facet extending an angle greater than 90° from the rear wall. The cover can have an open area that is greater than 65%. The radiant heating element can be an infrared emitter.

In a further embodiment, the cover has an open area that is greater than 65%, The open area can be at least 79%.

According to another aspect of the invention, a sauna comprises a cabinet defining an interior and having an opening providing access to the interior, a door mounted to the cabinet and moveable between a closed position, where the door blocks human access from an exterior of the cabinet through the opening to the interior, and an open position, where human access is permitted from the exterior through the opening to the interior, a radiant heating element for supplying heat to the interior, and a cover disposed between the radiant heating element and the interior and having multiple openings, and having an open area that is greater than 65%. The open area can be at least 79%.

In another embodiment, the each opening has an effective size that is less than 0.3 inches. The effective size can be ¼ inch. The openings can be hexagonal.

In yet another embodiment, the radiant heating element is an infrared emitter.

According to yet another aspect of the invention, a sauna comprises a cabinet defining an interior and having an opening providing access to the interior, a door mounted to the cabinet and moveable between a closed position, where the door blocks human access from an exterior of the cabinet through the opening to the interior, and an open position, where human access is permitted from the exterior through the opening to the interior, and a heat source comprising a housing having a rear wall from which extends a multifaceted peripheral side wall, with each facet extending an angle greater than 90° from the rear wall, a radiant heating element located within the housing and supplying heat to the interior, and a cover disposed between the radiant heating element and the interior and having multiple openings.

In one embodiment, the multifaceted peripheral side wall comprises two spaced side facets and two spaced end facets joining the two side facets. At least two facets can be oriented at a different angle with respect to the rear wall.

In another embodiment, the facets extend from the rear wall at an angle between 115° and 150° degrees.

In yet another embodiment, the cover has an open area that is greater than 65%.

In still another embodiment, the radiant heating element is an infrared emitter.

### BRIEF DESCRIPTION OF THE DRAWINGS

In the drawings:

FIG. 1 is a perspective view of a sauna, with the doors open to illustrate the interior of the sauna.

FIG. 2 is a front perspective schematic illustration of an infrared emitter unit according to the present invention.

FIG. 3 is a side perspective schematic illustration of the infrared emitter unit from FIG. 2.

FIG. 4 is a partial cross-section view through line 4-4 of FIG. 2.

FIG. 5 is a partial cross-section view through line 5-5 of FIG. 2

FIG. 6 is a close-up view of a screen for the infrared emitter unit from FIG. 2.

### DESCRIPTION OF THE PREFERRED EMBODIMENT

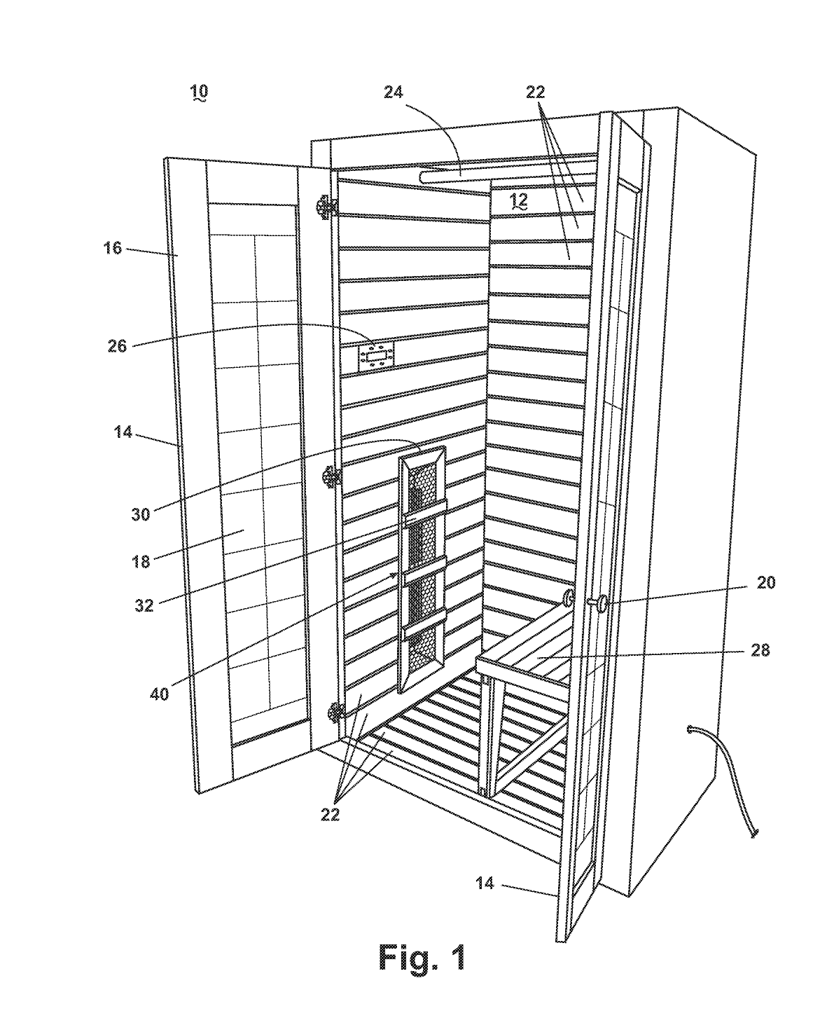

Referring now to the drawings, and in particular to FIG. 1, an illustrative example of a sauna 10 is shown comprising a heat source shown as an infrared emitter unit 40. The sauna 10 comprises a substantially box-like structure defining an interior space 12. The exterior walls of the sauna 10 are preferably made of wood. The sauna 10 is provided with a pair of doors 14 that are openable to permit entrance into the interior space 12 of the sauna 10. The doors 14 can comprise a wooden frame 16 supporting a tempered glass panel 18 and a handle 20.

The side walls, floor panel, and ceiling panel of the interior space 12 are preferably covered with or constructed of multiple slats 22 of unfinished wood, such as birch cedar, redwood, hemlock, aspen and white spruce. The interior space 12 can further comprise other elements that are not germane to the invention, such as a hanging rod 24 for hanging items within the interior space 12, a user interface 26 for controlling the operation of the sauna 10, a bench 28 allowing one or more users to sit in the interior space 12, and various other elements common to saunas.

The sauna 10 is suited for incorporation into static structures, such as houses, apartments, condominiums, hotels, gyms, and other buildings, and also mobile structures, such as recreational vehicles (RVs), trailers, mobile homes, cruise ships, and houseboats.

The sauna of FIG. 1 is for illustrative purposes only and is not limiting on the invention. The structure and construction of the sauna is not germane to the invention. Any sauna structure can be used.

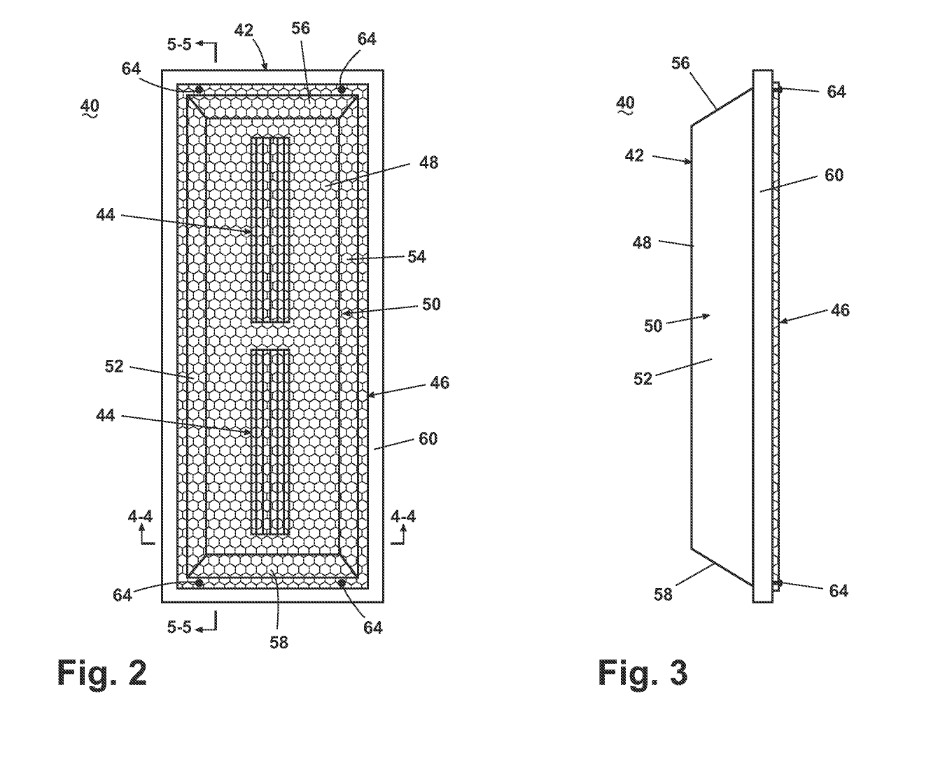

Referring to FIGS. 2 and 3, the infrared emitter unit 40 comprises a housing 42, at least one infrared emitter 44, and a cover 46. Other elements not illustrated, but that can be included with the infrared emitter unit 40 include reflectors, controls, thermostats, wiring, and other elements common to infrared emitter units. The infrared emitter unit 40 is provided to heat the interior space 12 and/or a sauna user. As is known in the dry sauna art, the infrared emitter unit 40 emits far infrared ray radiation.

In the illustrated embodiment, the infrared emitter unit 40 is recessed in an interior side wall of the sauna 10 and emits radiation inwardly toward the interior space 12. The infrared emitter unit 40 is shown positioned on an interior side wall of the sauna 40, however, the location of the infrared emitter unit 40 can be varied. The sauna 10 can further be provided with more than one infrared emitter unit 40. The infrared emitter unit 40 can be partially covered by a wooden frame 30 crossed by generally horizontal slats 32 attached to the frame 30 to reduce or minimize direct contact between the user and the screen 46 that might otherwise deform or deflect the cover 46. The wooden frame 30 and slats 32 can also be configured as a back rest for the user in the event that the infrared emitter unit 40 is position behind the bench 28. However, it is desirable to minimize the number of slats as they will limit the transfer of heat into the sauna.

The housing 42 has an open face formed by a rear wall 48 from which extends a multifaceted peripheral side wall 50. As illustrated, the peripheral side wall 50 comprises a right side facet 52, a left side facet 54, a top facet 56, and a bottom facet 58 joined together to form a generally box-like structure. A flange 60 extends from the peripheral side wall 50 such that it is generally parallel to the rear wall 48 and surrounds the open front face of the housing 42.

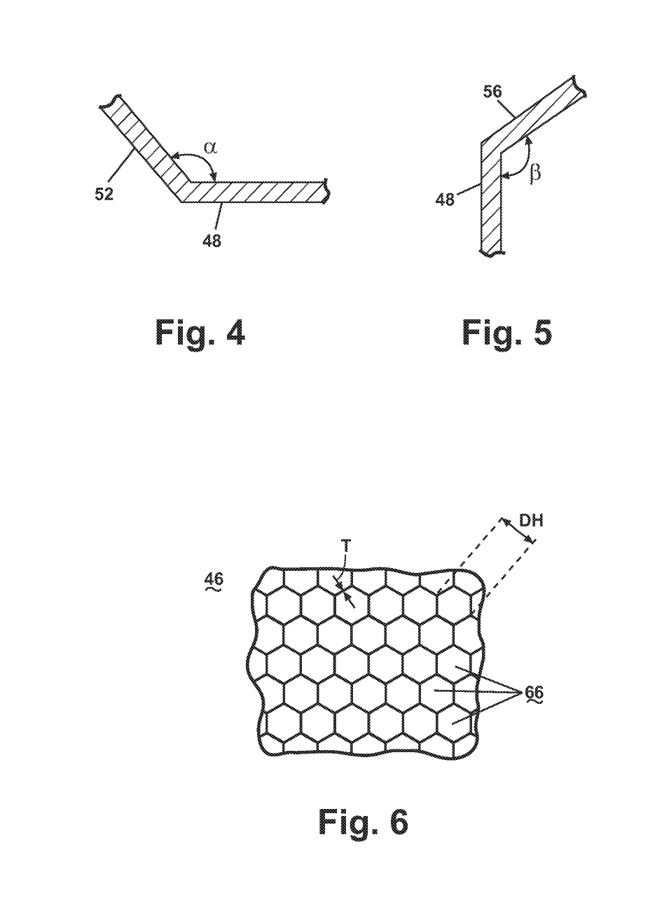

Referring to FIG. 4, the right and left side facets 52, 54 are spaced from one another and meet the rear facet 48 at an angle α that is equal to or greater than 90°. Likewise, referring to FIG. 5, the top and bottom facets 56, 58 are spaced from one another and meet the rear facet at an angle β that is equal to or greater than 90°. Preferably, angles α and β are greater than 90°. More preferably, angles α and β range from 115° to 150°. The angled peripheral side wall 50 increases the efficiency of the infrared heater unit 40, as compared with a heater unit having a housing with walls joined at right angles, because more heat is reflected through the opening into the interior space, resulting in less heat buildup at the angled peripheral side wall 50 as compared to the currently used side wall.

In the illustrated embodiment, the infrared emitter unit 40 comprises two infrared emitters 44, however, the infrared emitter unit 40 may comprise one emitter 44, or multiple emitters 44. The infrared emitter 44 can be a ceramic emitter, a steel (Incoloy) rod heater, or any other type infrared emitter known in the infrared sauna art. It is also within the scope of the invention to employ other non-infrared radiant heating elements to supply heat to the interior space 12.

The cover 46 is disposed between the infrared emitters 44 and the interior space 12 and prevents a user from directly contacting the infrared emitters 44. In the illustrated embodiment, the cover 46 overlies the open front face 62 of the housing 42. The cover 46 can be mounted to the flange 60 using suitable fasteners, such as screws or bolts 64. The cover 46 is preferably made of a metal, for example, steel, galvanized steel, stainless steel, monel (alloy of nickel, copper, iron, and other trace elements), brass, copper, aluminum, zinc, or tin. The cover 46 is preferably made from galvanized steel.

Referring to FIG. 6, a close-up view of the screen 46 is illustrated. The cover 46 has multiple openings 66 having an effective size that prevents an anticipated user, even a child user, from inserting a finger through one of the openings 66. The effective size can be described in terms of an effective diameter, which is defined as the maximal diameter that can be measured between two points of the opening. It has been determined that 0.3 inches represents a standard minimum finger size of an anticipated user. This is approximately the diameter of a standard No. 2 pencil. Thus, the effective size is preferably less than 0.3 inches. More preferably, the effective size is ¼ inch.

In the illustrated embodiment, the openings 66 are hexagonal and form a honeycomb-like pattern. Each hexagonal opening 66 has a maximal diameter D_{H} measured between two opposing vertices of the hexagon and an area A_{H}. Preferably, the diameter D_{H} is less than 0.3 inches. More preferably, the diameter D_{H} is ¼ inch.

Another important dimension of the cover 46 is the thickness T of the material between adjacent openings 66. The thickness T can be uniform or can vary across the cover 46. The thickness T of the cover 46 should be chosen so that the cover 46 can withstand anticipated pressures without deforming. The material used for the cover 46 is also a consideration when determining a suitable thickness T, since a cover 46 made from a stronger material can have a smaller thickness T and still withstand anticipated pressures without deforming.

In addition to preventing a user from contacting the heating elements, the cover should block as little heat as possible to minimize heat build up in the housing and maximize the heat transferred into the sauna. To accomplish these conflicting goals, the cover 46 has an open area, which can be quantified as the percentage of open area in the cover relative to the total area, and is directly related to the heat radiation efficiently of the infrared heater unit 40. The open area can be determined by dividing the total sum of the areas of the openings 66 in the cover 46 by the area of the cover. The open area is also affected by the thickness T of the cover 46.

A large open area is desired in order to most efficiently transfer heat into the sauna, and this is most effectively accomplished by maximizing the area of each opening 66 and minimizing the thickness T. However, the area of each opening 66 can only be maximized up to a certain point for safety concerns, since the effective size is preferably less than 0.3 inches to prevent the anticipated user from inserting a finger through one of the openings 66. Another safety concern arises when minimizing the thickness T. If the thickness T becomes too small, pressure on the cover 46 may deform or break the cover 46 and possibly allow contact with the infrared emitter 44. Therefore, the open area of the cover 46 must be optimized with a suitable effective size of the openings 66 and thickness T.

Preferably, the cover 46 has an open area that is greater than 65%. More preferably, the cover 46 has an open area that is at least 79%. For a cover 46 comprising hexagonal openings 66 having a diameter D_{H} of ¼ inches and a thickness T of about 0.04 inches, the open area was determined to be 79%.

While the cover 46 is illustrated as having hexagonal openings 66, it is understood that other shapes can be used. Examples of suitable opening shapes for the cover 46 include triangles, squares, rectangles, diamonds, pentagons, octagons, circles, ovals, ellipses, clovers, or a mixture thereof. The cover 46 can also comprise an opening pattern comprising a mixture of opening shapes and sizes of opening shapes. The openings 66 can also be arranged to be irregular or non-repeating.

The infrared heater unit insures the safety of users by employing a cover over the infrared emitter having openings of a effective size that prevents a user from inserting a finger through the cover. However, the open area of the cover and the housing shape still provides an efficient heating of the sauna interior.

While the invention has been specifically described in connection with certain specific embodiments thereof, it is to be understood that this is by way of illustration and not of limitation, and the scope of the appended claims should be construed as broadly as the prior art will permit.

What is claimed is:

1. A sauna comprising:
a cabinet defining an interior and having an opening providing access to the interior;
a door mounted to the cabinet and moveable between a closed position, where the door blocks human access from an exterior of the cabinet through the opening to the interior, and an open position, where human access is permitted from the exterior through the opening to the interior;
a radiant heating element supplying heat to the interior; and
a cover disposed between the radiant heating element and the interior and having multiple openings, each opening having an effective size to prevent the insertion of a child's finger having a standard size.

2. The sauna according to claim 1 wherein the effective size is less than 0.3 inches.

3. The sauna according to claim 2 wherein the effective size is ¼ inch.

4. The sauna according to claim 1 wherein the radiant heating element is an infrared emitter.

5. The sauna according to claim 1 wherein the openings are hexagonal.

6. The sauna according to claim 5 wherein the hexagonal openings have a maximal diameter of ¼ inch.

7. The sauna according to claim 1, and further comprising a housing mounted to the cabinet and in which the radiant heating element is located, with the housing having a rear wall from which extends a multifaceted peripheral side wall, with each facet extending an angle greater than 90° from the rear wall.

8. The sauna according to claim 7 wherein the cover has an open area that is greater than 65%.

9. The sauna according to claim 8 wherein the radiant heating element is an infrared emitter.

10. The sauna according to claim 1 wherein the cover has an open area that is greater than 65%.

11. The sauna according to claim 10 wherein the open area is at least 79%.

12. A sauna comprising:
a cabinet defining an interior and having an opening providing access to the interior;
a door mounted to the cabinet and moveable between a closed position, where the door blocks human access from an exterior of the cabinet through the opening to the interior, and an open position, where human access is permitted from the exterior through the opening to the interior;
a radiant heating element for supplying heat to the interior; and
a cover disposed between the radiant heating element and the interior and having multiple openings, and having an open area that is greater than 65%.

13. The sauna according to claim 12 wherein the open area is at least 79%.

14. The sauna according to claim 12 wherein each opening has an effective size that is less than 0.3 inches.

15. The sauna according to claim 14 wherein the effective size is ¼ inch.

16. The sauna according to claim 15 wherein the openings are hexagonal.

17. The sauna according to claim 12 wherein the radiant heating element is an infrared emitter.

18. A sauna comprising:
a cabinet defining an interior and having an opening providing access to the interior;
a door mounted to the cabinet and moveable between a closed position, where the door blocks human access from an exterior of the cabinet through the opening to the interior, and an open position, where human access is permitted from the exterior through the opening to the interior; and
a heat source comprising;
a housing having a rear wall from which extends a multifaceted peripheral side wall, with each facet extending an angle greater than 90° from the rear wall;
a radiant heating element located within the housing and supplying heat to the interior; and
a cover disposed between the radiant heating element and the interior and having multiple openings.

19. The sauna according to claim 18 wherein the multifaceted peripheral side wall comprises two spaced side facets and two spaced end facets joining the two side facets.

20. The sauna according to claim 19 wherein at least two facets are oriented at a different angle with respect to the rear wall.

21. The sauna according to claim 18 wherein the facets extend from the rear wall at an angle between 115° and 150°.

22. The sauna according claim 18 wherein the cover has an open area that is greater than 65%.

23. The sauna according to claim 18 wherein the radiant heating element is an infrared emitter.
